(19) United States
(12) Patent Application Publication
(10) Pub. No.: US 2019/0276359 A1
(43) Pub. Date: Sep. 12, 2019

(54) UNSATURATED POLYESTER RESIN FOR ENGINEERED STONE COMPRISING FINE AND/OR POROUS PARTICLES

(71) Applicant: ASLAND LICENSING AND INTELLECTUAL PROPERTY LLC, Dublin, OH (US)

(72) Inventors: Pirjo Leena NISSILÄ, Espoo (ES); Taru Anniina NIKKONEN, Vantaa (FI); José Luís Miquel PERAIRE, Barcelona (ES); Makan NOROZE, Valencia (ES); Javier López De Alda MADORRAN, BENICARLO (ES)

(73) Assignee: ASLAND LICENSING AND INTELLECTUAL PROPERTY LLC, Dublin, OH (US)

(21) Appl. No.: 16/346,468

(22) PCT Filed: Oct. 30, 2017
(86) PCT No.: PCT/US17/58963

§ 371 Date: Apr. 30, 2019

Related U.S. Application Data
(60) Provisional application No. 62/412,707, filed on Oct. 25, 2016.

(51) Int. Cl. C04B 26/18; C08G 63/547; C08G 63/83; C04B 14/06

(52) U.S. Cl. CPC C04B 26/18; C08G 63/547; C04B 2111/54; C04B 14/06; C08G 63/83

(57) ABSTRACT

The invention relates to an unsaturated polyester resin of low molecular weight which is useful for the preparation of engineered stone. When mixing the unsaturated polyester resin with a fine inorganic particulate material such as cristobalite, a formable composition is obtained that can be further processed and cured to finally yield engineered stone as composite material. The invention also relates to a method for the preparation of engineered stone as well as to the use of the unsaturated polyester resin for the preparation of engineered stone.

The invention relates to an unsaturated polyester resin of low molecular weight which is useful for the preparation of engineered stone. When mixing the unsaturated polyester resin with a fine and/or porous inorganic particulate material such as fine quartz and/or cristobalite, a formable composition is obtained that can be further processed and cured to finally yield engineered stone as composite material. The invention also relates to a method for the preparation of engineered stone as well as to the use of the unsaturated polyester resin for the preparation of engineered stone.

In the conventional manufacture of engineered stone slabs, a resin formulation is mixed with crushed stone, typically quartz fillers and/or quartz aggregates of defined particle sizes. The resin formulation is curable upon activation by addition of a metal catalyst and peroxide. After addition of said metal catalyst and peroxide, curing of the resin formulation commences and proceeds until the resin has been completely cured. During the interim period (pot life) the curing composition can be formed into the desired shape of the engineered stone.

U.S. Pat. No. 8,026,298 relates to a method for the preparation of engineered stone slab having coated lumps of composite stone material. U.S. Pat. No. 8,436,074 relates to artificial marble, and system and method of producing artificial marble.

U.S. Pat. No. 4,032,596 pertains to curing of unsaturated polyester resins in admixture with ethylenically unsaturated copolymerizable monomers and is particularly concerned with promoting or accelerating the cross linking of such polyester with such vinyl monomers during curing while retaining serviceable shelf-life during storage of the permix at ambient or room temperatures.

WO 2012/104020 relates to a gelcoat composition comprising a reactive polyester resin and a particulate inorganic filler and to a method of applying the gelcoat composition to suitable substrates such as sanitary basins, e.g. sinks, washbasins, spas, shower basins, lavatories, and the like. The solidified gelcoat provides excellent scratch resistance to the surface of the substrate.

GB-A 834 286 discloses that the storage life of a copolymerizable mixture of an unsaturated alkyd resin and an ethylenic monomer copolymerizable therewith, which mixture contains an inhibitor against premature gelation, can be improved by adding thereto, a copper compound soluble in the alkyd resin mixture in an amount ranging from 0.25 to 10 parts per million, based on the weight of the resinous mixture.

U.S. Pat. No. 3,028,360 is concerned with improving the storage life of polyester resins.

EP-A 2 610 227 discloses an artificial marble including unsaturated polyester resin (A), compound containing silica (B), and luminescent pigment (C).

WO2016/003867 relates to a formable composition for the preparation of engineered stone comprising a prepromoted unsaturated polyester resin system, an inorganic particulate material and a peroxide component.

Conventional resin formulations are not satisfactory in every respect and there is a demand for methods for the preparation of engineered stone that have advantages compared to the prior art. The engineered stone should be easy to manufacture by means of conventional equipment and should have excellent optical and mechanical properties.

This object has been achieved by the subject-matter of the patent claims.

It has been surprisingly found that engineered stone having excellent optical and mechanical properties can be prepared from fine particulate material, especially quartz and cristobalite, and an unsaturated polyester resin having a comparatively low molecular weight and viscosity.

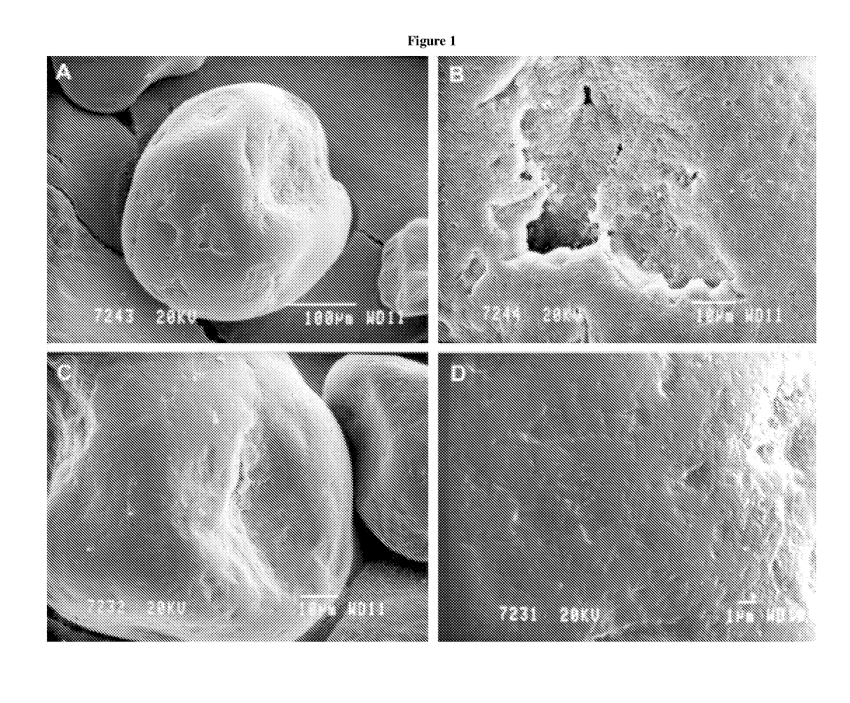

The unsaturated polyester resin according to the invention is particularly useful for the manufacture of engineered stone from cristobalite, which is a silicon dioxide filler that can be obtained e.g. by high temperature polymorph transformation of quartz or silica. Cristobalite has a very white color and the individual particles are characterized by a plurality of micro holes (see FIG. 1). Fine quartz also has a very white color.

Without wishing to be bound to any scientific theory, the unsaturated polyester resin according to the invention is capable of penetrating these micro holes thereby filling them and providing the cured engineered stone with substantially better mechanical properties compared to conventional slabs made from cristobalite with conventional resins.

The unsaturated polyester resin according to the invention can be used in comparatively low amounts relative to the amount of particulate material, e.g. cristobalite. Conventional resins require higher amounts, as the wetting properties of such conventional resins are limited. Stone slabs made from conventional resins tend to bend upon curing at high temperatures inside the curing oven. In consequence, these stone slabs need to be repolished after curing.

It has now been surprisingly found that the bending tendency of the stone slabs that are manufactured from the unsaturated polyester resin according to the invention have a substantially less pronounced bending tendency, if any, as well as substantially improved mechanical properties. As less bending occurs, laborious repolishing of the cured material can be reduced substantially.

Further, it has been surprisingly found that stone slabs show substantially less cracks, if any, when they are manufactured from resins which are derived from fumaric acid partially or completely substituting maleic acid or maleic acid anhydride. It is well known that copolymerization reactivity of fumarate with styrene is almost 20 times higher than that for maleate. [Osama M. Musa, Handbook of Maleic Anhydride Based Materials: Synthesis, Properties and Applications, Springer, 2017, Vol 1, pp. 251-310] Unsaturated polyester resins are typically synthesized by using maleic anhydride that isomerizes to fumarate during polymer esterification reaction. The degree of isomerization is dependent on type of glycols used and improves by increase of polymer esterification reaction time and temperature. Substituting maleic anhydride with fumaric acid can be therefore advantageous, as it initially ensures high content of reactive fumarate double bonds, and thus, results in higher crosslink density when the resin is cured. Finally, it's important to optimize amount of crosslinking double bonds in proportion to reactive diluent and to other components in the unsaturated polymer structure. Resins with too high content of reactive double bonds, can be too rigid or brittle to be employed in the manufacture of engineered stone slabs. It has been found that stone slabs that are manufactured from the unsaturated polyester resin according to the invention show substantially less cracks and brittleness.

Furthermore, it has been surprisingly found that stone slabs prepared from resins comprising adipic acid or a mixture of adipic acid with phthalic anhydride show considerably improved mechanical properties with respect to flexural strength and impact resistance. It is known that the aliphatic carbon chain of the adipic acid will enhance flexibility of the stone slab and reduce cracks.

Thus, the unsaturated polyester resin according to the invention can be manufactured and processed easily and provides better properties at lower consumption.

Even further, it has been surprisingly found that the unsaturated polyester resin according to the invention requires lower amounts of reactive diluents such as styrene. Due to low styrene content compared with conventional resins, the residual content of styrene in the cured stone slabs is reduced, if any, thereby avoiding styrene-styrene polymers causing poor mechanical properties and also having poor UV resistance due to free aromatic conjugated double bonds.

A first aspect of the invention related to an unsaturated polyester resin component for the preparation of engineered stone, wherein the unsaturated polyester resin component has a weight average molecular weight of not more than about 2500 g/mol and is obtained or is obtainable by reacting a mixture comprising
(i) a polycarboxylic acid component comprising at least 2 polycarboxylic acids, wherein a first carboxylic acid is selected from the group consisting of unsaturated aliphatic polycarboxylic acids, anhydrides or esters thereof and a second polycarboxylic acid is selected from the group consisting of saturated aliphatic polycarboxylic acids, anhydrides or esters thereof;
(ii) a polyfunctional alcohol component comprising at least one polyfunctional alcohol selected from the group consisting of saturated aliphatic polyfunctional alcohols and unsaturated aliphatic polyfunctional alcohols;
(iii) optionally, a monocarboxylic acid component comprising at least one monocarboxylic acid selected from aromatic monocarboxylic acids, anhydrides or esters thereof; saturated aliphatic monocarboxylic acids, anhydrides or esters thereof; and unsaturated aliphatic monocarboxylic acids, anhydrides or esters thereof; and
(iv) optionally, a monofunctional alcohol component comprising at least one monofunctional alcohol selected from aromatic monofunctional alcohols, saturated aliphatic monofunctional alcohols, and unsaturated aliphatic monofunctional alcohols;
   wherein the polycarboxylic acid component and/or the polyfunctional alcohol component and/or the monocarboxylic acid component and/or the monofunctional alcohol component comprises ethylenic unsaturation.

For the purpose of the invention, “poly” means “at least two”. Thus, a polycarboxylic acid has at least two carboxylic groups (diacid, triacid, etc.), whereas a polyfunctional alcohol has at least two hydroxyl groups (diol, triol, etc.).

For the purpose of the invention, “component” refers to a constituent that may be composed of a single compound or of a plurality (e.g. mixture) of compounds having a common property. For example, a polycarboxylic acid component may consist of a single polycarboxylic acid or of a mixture of 2, 3 or 4 different polycarboxylic acids. For the purpose of the specification, unless expressly stated otherwise, all values referring to a component refer to the total quantity of said component, i.e. to the plurality of all compounds having said common property.

For the purpose of the specification, definitions of weight contents of monomers that are incorporated in the polyester backbone may be related to the total weight of the resultant polyester resin after esterification. A skilled person recognizes that depending upon the starting materials, condensation reactions may occur or not. For example, esterification of ethylene glycol with fumaric acid releases one equivalent of water, whereas the same reaction with the acid anhydride does not release water. For the ease of specification, the water that may be released in the course of the reaction is preferably to be disregarded. Accordingly, unless expressly stated otherwise, any weight percentages of e.g. a carboxylic acid preferably refer to the residual equivalent molecular weight of the carboxylic acid moiety that is finally incorporated in the polymer backbone, irrespective of whether it is employed in form of the free acid or e.g. in form of an anhydride thereof.

Unsaturated polyester resin components are known to a skilled person and for the purposes of the invention not particularly limited. Typically, the unsaturated polyester resin components according to the invention are characterized by a polymerizable C═C double bond, optionally in conjugation with a carbonyl bond.

These unsaturated polyester resin components are obtained or are obtainable by the condensation of carboxylic acid monomers with polyfunctional alcohol monomers. The polyester may then be dissolved in a reactive monomer, such as styrene, to obtain a solution that may then be crosslinked. One skilled in the art will appreciate that there are many different processes and methods for making unsaturated polyester resin components and other resins having ethylenic unsaturation that may be applied within the scope of the invention.

Preferably,
(i) the polycarboxylic acid component comprises fumaric acid and adipic acid; and
(ii) the polyfunctional alcohol component comprises propylene glycol and diethylene glycol.

Preferably, the molar content of the second polycarboxylic acid which is selected from the group consisting of saturated aliphatic polycarboxylic acids, anhydrides or esters thereof is not more than 13.5 mole.-%, more preferred not more than 13.0 mole.-%, most preferred not more than 12.5 mole.-% relative to the molar content of the polycarboxylic acid component.

Preferably, the unsaturated polyester resin component according to the invention is obtained or is obtainable by reacting a mixture comprising a polycarboxylic acid component (free acid, salt, ester, anhydride) and a polyfunctional alcohol component, wherein the polycarboxylic acid component and/or the polyfunctional alcohol component comprises ethylenic unsaturation. Said mixture may also comprise saturated or unsaturated, aliphatic or aromatic monocarboxylic acids and/or saturated or unsaturated, aliphatic or aromatic monofunctional alcohols in order to adjust the average molecular weight of the polyester molecules.

Preferably, the unsaturated polyester resin component is obtained or is obtainable by reacting a mixture comprising a polyfunctional alcohol and a carboxylic acid, a carboxylic acid ester and/or a carboxylic acid anhydride, i.e. the unsaturated polyester resin component is derived from a monomer composition (in the following also referred to as “mixture”) comprising a polyfunctional alcohol and a carboxylic acid, a carboxylic acid ester and/or a carboxylic acid anhydride.

In a preferred embodiment, the mixture comprises a polyfunctional alcohol and a polycarboxylic acid, a polycarboxylic acid ester and/or a polycarboxylic acid anhydride, i.e. the unsaturated polyester resin component is the condensation product of one or more polycarboxylic acids, polycarboxylic acid esters and/or polycarboxylic acid anhydrides with one or more polyfunctional alcohols. More preferably, the mixture comprises a polyfunctional alcohol and a polycarboxylic acid and/or a polycarboxylic acid anhydride, i.e. the unsaturated polyester resin component is the condensation product of one or more polycarboxylic acids and/or polycarboxylic acid anhydrides with one or more polyfunctional alcohols.

The unsaturated polyester resin component according to the invention has a weight average molecular weight of not more than about 2500 g/mol, preferably not more than about 2200 g/mol; more preferably not more than about 2100 g/mol, still more preferably not more than about 2000 g/mol, yet more preferably not more than about 1900 g/mol, even more preferably not more than about 1800 g/mol or not more than about 1700 g/mol, and in particular not more than about 1500 g/mol.

Suitable methods for measuring the weight average molecular weight of unsaturated polyester resins are known to the skilled person and include size exclusion chromatography.

Suitable methods for altering the weight average molecular weight of unsaturated polyester resins are known to the skilled person. The average molecular weight can be influenced by the content of polyfunctional monomers thereby influencing the degree of cross-linking, as well as by the content of monofunctional monomers thereby influencing the degree of end-capping.

Preferably, the unsaturated polyester resin component according to the invention has a viscosity (prior to curing) in the range of about 150 to about 400 mPas. More preferred, the unsaturated polyester resin component according to the invention has a viscosity in the range of about 200 to about 350 mPas, even more preferred in the range of about 200 to about 300 mPas. Preferably, the viscosity is measured according to ISO 2555 in a Brookfield viscometer at 25° C.

Preferably, the unsaturated polyester resin component according to the invention has a viscosity (prior to mixing with additives) in the range of about 400 to about 500 mPas at 100° C., more preferably in the range of about 400 to about 450 mPas at 100° C. Preferably, the viscosity is measured according to ISO 2555 in a Brookfield viscometer. The aforementioned viscosity relates to the viscosity of the unsaturated polyester resin component as such without any additives, solvents, diluents and the like, i.e. the unsaturated polyester resin component only consisting of
(i) a polycarboxylic acid component as defined above;
(ii) a polyfunctional alcohol component as defined above;
(iii) optionally, a monocarboxylic acid component as defined above; and
(iv) optionally, a monofunctional alcohol component as defined above; wherein the polycarboxylic acid component and/or the polyfunctional alcohol component and/or the monocarboxylic acid component and/or the monofunctional alcohol component comprises ethylenic unsaturation.

The unsaturated polyester resin component according to the invention is obtained or is obtainable from a monomer mixture comprising a polycarboxylic acid component comprising at least two polycarboxylic acids independently of one another selected from the group consisting of aromatic polycarboxylic acids, anhydrides or esters thereof; saturated aliphatic polycarboxylic acids, anhydrides or esters thereof; and unsaturated aliphatic polycarboxylic acids, anhydrides or esters thereof.

In a preferred embodiment, the polycarboxylic acid component comprises a carboxylic acid, a carboxylic acid ester and/or a carboxylic acid anhydride, wherein the carboxylic acid, the carboxylic acid ester and/or the carboxylic acid anhydride are/is selected from aliphatic and aromatic polycarboxylic acids and/or the esters and anhydrides thereof, wherein the term “aliphatic” covers acyclic and cyclic, saturated and unsaturated polycarboxylic acids and the esters and anhydrides thereof. Preferably, the carboxylic acid, the carboxylic acid ester and/or the carboxylic acid anhydride are/is selected from unsaturated and aromatic polycarboxylic acids and/or the esters and anhydrides thereof. More preferably, the carboxylic acid, the carboxylic acid ester and/or the carboxylic acid anhydride are/is selected from unsaturated polycarboxylic acids and/or the esters and anhydrides thereof.

In another preferred embodiment, the polycarboxylic acid component comprises a carboxylic acid, a carboxylic acid ester and/or a carboxylic acid anhydride, wherein the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aliphatic and/or aromatic polycarboxylic acids and/or the esters and anhydrides thereof. Preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from saturated and/or aromatic polycarboxylic acids and/or the esters and anhydrides thereof. More preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aromatic polycarboxylic acids and/or the esters and anhydrides thereof. Even more preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aromatic polycarboxylic acids and/or the esters and anhydrides thereof, wherein the second carboxylic acid, carboxylic acid ester and/or carboxylic acid anhydride have/has a limited weight proportion in the reactive unsaturated polyester resin system compared to the carboxylic acid, the carboxylic acid ester and/or the carboxylic acid anhydride selected from unsaturated polycarboxylic acids and/or the esters and anhydrides thereof, the weight ratios (second carboxylic acid, carboxylic acid ester and/or carboxylic acid anhydride:carboxylic acid, the carboxylic acid ester and/or the carboxylic acid anhydride selected from unsaturated polycarboxylic acids and/or the esters and anhydrides thereof) being less than about 0.8:1, preferably less than about 0.5:1, more preferably about less than 0.2:1, even more preferably less than about 0.1:1, and most preferably less than about 0.05:1.

The use of the saturated and/or aromatic polycarboxylic acids, polycarboxylic acid esters and/or polycarboxylic acid anhydrides in combination with unsaturated polycarboxylic acids, polycarboxylic acid esters and/or polycarboxylic acid anhydrides may serve to decrease the crosslink density after curing of the unsaturated polyester resin component, and consequently the unsaturated polyester resin component will typically be more flexible, shock resistant, unbrittle, and the like.

In another preferred embodiment, the polycarboxylic acid component comprises a blend of a carboxylic acid, a carboxylic acid ester and/or a carboxylic acid anhydride, wherein the carboxylic acid, the carboxylic acid ester and/or the carboxylic acid anhydride are/is selected from aliphatic and aromatic dicarboxylic acids and/or the esters and anhydrides thereof, wherein the term “aliphatic” covers acyclic and cyclic, saturated and unsaturated dicarboxylic acids and the esters and anhydrides thereof. Preferably, a first carboxylic acid, the carboxylic acid ester and/or carboxylic acid anhydride are/is selected from unsaturated dicarboxylic acids and/or esters and anhydrides thereof, and is used in combination with a second carboxylic acid, carboxylic acid ester and/or carboxylic acid anhydride, which are/is selected from saturated and/or aromatic polycarboxylic acids and/or the esters and anhydrides thereof. More preferably, a first carboxylic acid and/or a carboxylic acid anhydride selected from fumaric acid, maleic acid, and maleic acid anhydride is used in combination with a second carboxylic acid and/or carboxylic acid anhydride selected from isophthalic acid, phthalic acid, terephthalic acid, and phthalic anhydride. More preferably, fumaric acid is used in combination with isophthalic acid or phthalic acid.

In a preferred embodiment, the polycarboxylic acid component comprises a binary mixture of
an aromatic polycarboxylic acid, anhydride or ester thereof with
a saturated aliphatic polycarboxylic acid, anhydride or ester thereof.

In a preferred embodiment, the polycarboxylic acid component comprises a binary mixture of
an aromatic polycarboxylic acid, anhydride or ester thereof with
an unsaturated aliphatic polycarboxylic acid, anhydride or ester thereof.

In a preferred embodiment, the polycarboxylic acid component comprises a binary mixture of
a saturated aliphatic polycarboxylic acid, anhydride or ester thereof with
an unsaturated aliphatic polycarboxylic acid, anhydride or ester thereof.

In a preferred embodiment, the polycarboxylic acid component according to the invention comprises a ternary mixture of
an aromatic polycarboxylic acid, anhydride or ester thereof; with
a saturated aliphatic polycarboxylic acid, anhydride or ester thereof; and with
an unsaturated aliphatic polycarboxylic acid, anhydride or ester thereof.

Preferred aromatic polycarboxylic acids are selected from aromatic dicarboxylaic acids, aromatic tricarboxylic acids, aromatic tetracarboxylic acids, and their corresponding acid anhydrides. A skilled person recognizes that the aromatic polycarboxylic acids may also be employed in form of esters, e.g. methyl esters or ethyl esters, in the corresponding transesterification reactions.

Exemplary aromatic polycarboxylic acids include isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acids are isophthalic acid, phthalic acid, terephthalic acid, and tetrachlorophthalic acid. More preferred aromatic polycarboxylic acids are isophthalic acid, and phthalic acid. The most preferred aromatic polycarboxylic acid is isophthalic acid.

Exemplary aromatic polycarboxylic acid esters can be derived from isophthalic acid, phthalic acid, terephthalic acid, tetrachlorophthalic acid, trimellitic acid, 1,2,4,5-benzenetetra-carboxylic acid, and 1,2,4-benzenetricarboxylic acid.

Exemplary aromatic polycarboxylic acid anhydrides can be derived from isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acid anhydrides are the aromatic polycarboxylic acid anhydrides of phthalic acid and tetrachlorophthalic acid. The most preferred aromatic polycarboxylic acid anhydride is phthalic anhydride.

Preferred saturated aliphatic polycarboxylic acids are selected from the group consisting of saturated aliphatic dicarboxylic acids, saturated aliphatic tricarboxylic acids, saturated aliphatic tetracarboxylic acids, and their corresponding acid anhydrides. A skilled person recognizes that the saturated aliphatic polycarboxylic acids may also be employed in form of esters, e.g. methyl esters or ethyl esters, in the corresponding transesterification reactions.

Exemplary saturated aliphatic polycarboxylic acids include adipic acid, chlorendic acid, dihydrophthalic acid, dimethyl-2,6-naphthenic dicarboxylic acid, d-methyl glutaric acid, dodecanedicarboxylic acid, glutaric acid, bexahydrophthalic acid, oxalic acid, malonic acid, suberic acid, azelaic acid, nadic acid, pimelic acid, sebacic acid, succinic acid, tetrahydrophthalic acid, 1,2-cyclohexane dicarboxylic acid, 1,3-cyclobexane dicarboxylic acid, 1,4-cyclohexane dicarboxylic acid, and Diels-Alder adducts made from maleic acid anhydride and cyclopentadiene. Preferred saturated polycarboxylic acids are succinic acid, glutaric acid, d-methyl glutaric acid, adipic acid, sebacic acid, and pimelic acid. More preferred saturated polycarboxylic acids are adipic acid, succinic acid, and glutaric acid.

Exemplary saturated polycarboxylic acid esters can be derived from adipic acid, chlorendic acid, dihydrophthalic acid, dimethyl-2,6-naphthenic dicarboxylic acid, d-methyl glutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic acid anhydride and cyclopentadiene.

Exemplary saturated polycarboxylic acid anhydrides can be derived from adipic acid, chlorendic acid, dihydrophthalic acid, dimethyl-2,6-naphthenic dicarboxylic acid, dimethylglutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic acid anhydride and cyclopentadiene. Preferred saturated polycarboxylic acid anhydrides are the saturated polycarboxylic acid anhydrides of chlorendic acid, dihydrophthalic acid, dimethylglutaric acid, glutaric acid, hexahydrophthalic acid, nadic acid, succinic acid, tetrahydrophthalic acid. More preferred saturated polycarboxylic acid anhydrides are dihydrophthalic anhydride, hexahydrophthalic anhydride, tetrahydrophthalic anhydride, and succinic anhydride.

Preferred unsaturated aliphatic polycarboxylic acids are selected from the group consisting of unsaturated aliphatic dicarboxylic acids, unsaturated aliphatic tricarboxylic acids, unsaturated aliphatic tetracarboxylic acids, and their corresponding acid anhydrides. A skilled person recognizes that the unsaturated aliphatic polycarboxylic acids may also be employed in form of esters, e.g. methyl esters or ethyl esters, in the corresponding transesterification reactions.

Exemplary unsaturated polycarboxylic acids include chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid, glutaconic acid, traumatic acid, muconic acid, nadic acid, methylnadic acid, tetrahydrophthalic acid, hexahydrophthalic acid. More preferred unsaturated polycarboxylic acids are fumaric acid and maleic acid. The most preferred unsaturated polycarboxylic acid is fumaric acid.

Exemplary unsaturated polycarboxylic acid esters can be derived from chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid.

Exemplary unsaturated polycarboxylic acid anhydrides can be derived from chloromaleic acid, citraconic acid, fumaric acid, itaconic acid, maleic acid, mesaconic acid, and methyleneglutaric acid.

Preferred unsaturated polycarboxylic acid anhydrides are the unsaturated polycarboxylic acid anhydrides of chloromaleic acid, maleic acid, citraconic acid, and itaconic acid. More preferred unsaturated polycarboxylic acid anhydrides are maleic acid anhydride, citraconic anhydride, and itaconic anhydride. The most preferred unsaturated polycarboxylic acid anhydride is maleic acid anhydride.

Preferably, the polycarboxylic acid component comprises a ternary mixture of
at least one aromatic dicarboxylic acid, anhydride or ester thereof; which is preferably selected from isophthalic acid, phthalic acid, and the anhydrides thereof; with
at least one saturated aliphatic dicarboxylic acid, anhydride or ester thereof, which is preferably adipic acid or adipic acid anhydride; and with
at least one unsaturated aliphatic dicarboxylic acid, anhydride or ester thereof; which is preferably selected from maleic acid, fumaric acid and the anhydrides thereof.

Preferably, the polycarboxylic acid component comprises at least one saturated aliphatic polycarboxylic acid, anhydride or ester thereof. Preferably, the at least one saturated aliphatic polycarboxylic acid, anhydride or ester thereof has at least 12 carbon atoms, more preferred at least 10 carbon atoms, even more preferred at least 9 carbon atoms and most preferred at least 8 carbon atoms. Preferably the at least one saturated aliphatic polycarboxylic acid, anhydride or ester thereof is adipic acid or adipic acid anhydride.

Preferably, the polycarboxylic acid component, more preferably the unsaturated polyester resin component, does not comprise maleic acid or maleic acid anhydride. For the purpose of the invention, the above means that the system contains substantially no maleic acid or maleic acid anhydride, preferably at most 10 ppm, more preferably at most 5 ppm, most preferably at most 1 ppm maleic acid or maleic acid anhydride, and in particular no detectable maleic acid or maleic acid anhydride at all. Suitable methods for determining the content of maleic acid or maleic acid anhydride in a system are known to the skilled person.

A skilled person will recognize that when maleic acid or maleic acid anhydride is employed in polyester synthesis, some maleic functionalities remain in the resin. Without wishing to be bound to any scientific theory, resins comprising a high content of maleic have a lot of reactive double bonds and can be too rigid or brittle to be employed in the manufacture of engineered stone slabs. Slabs prepared from such resins typically show cracks.

Preferably, the weight content of the polycarboxylic acid component is within the range of about 55±31 wt.-%, more preferably about 55±30 wt.-%, still more preferably about 55±25 wt.-%, yet more preferably about 55±20 wt.-%, even more preferably about 55±15 wt.-%, most preferably about 55±10 wt.-%, and in particular about 55±5 wt.-%; in each case relative to the total weight of the polycarboxylic acid component, the polyfunctional alcohol component, the optionally present monocarboxylic acid component, and the optionally present monofunctional alcohol component.

In preferred embodiments of the polycarboxylic acid component according to the invention,
the molar content of the at least one aromatic dicarboxylic acid, anhydride or ester thereof is within the range of about 25±23 mole.-%, more preferably about 25±18 mole.-%, still more preferably about 25±15 mole.-%, yet more preferably about 25±12 mole.-%, even more preferably about 25±9 mole.-%, most preferably about 25±6 mole.-% and in particular about 25±3 mole.-%, in each case based on all aromatic dicarboxylic acids, anhydrides or esters thereof; and/or
the molar content of the at least one saturated aliphatic dicarboxylic acid, anhydride or ester thereof is within the range of; and about 12.5±10.5 mole.-%, more preferably about 12.5±9.0 mole.-%, still more preferably about 12.5±7.5 mole.-%, yet more preferably about 12.5±6.0 mole.-%, even more preferably about 12.5±4.5 mole.-%, most preferably about 12.5±3.0 mole.-% and in particular about 12.5±1.5 mole.-%, in each case based on all saturated aliphatic dicarboxylic acids, anhydrides or esters thereof; and/or
the molar content of the at least one unsaturated aliphatic dicarboxylic acid, anhydride or ester thereof is within the range of about 65±31 mole.-%, more preferably about 65±30 mole.-%, still more preferably about 65±25 mole.-%, yet more preferably about 65±20 mole.-%, even more preferably about 65±15 mole.-%, most preferably about 65±10 mole.-% and in particular about 65±5 mole.-%, in each case based on all saturated aliphatic dicarboxylic acids, anhydrides or esters thereof;
   in each case relative to the total molar content of (i) the polycarboxylic acid component.

Preferably, the unsaturated polyester resin component comprises a polycarboxylic acid component, wherein the molar ratio of (adipic acid or adipic acid anhydride) to (phthalic acid or phthalic acid anhydride) in the unsaturated polyester resin component is in the range of (0.5 to 3):(1.5 to 3), more preferably in a range of (0.7 to 1.5):(2 to 3), most preferred in a range of about (1):(3). Without wishing to be bound to any scientific theory it is believed that the aliphatic carbon chain of the adipic acid will enhance flexibility of the stone slab.

Preferably, the unsaturated polyester resin component comprises a polycarboxylic acid component, wherein the molar ratio of (saturated aliphatic polycarboxylic acids, anhydrides or esters thereof) to (unsaturated aliphatic polycarboxylic acids, anhydrides or esters thereof) in the polyester resin component is in a range of (0.5 to 1.5):(6.5 to 8.5), more preferably in a range of (0.8 to 1.2):(6.8-7.8), most preferred in a range of about (1):(7.5).

The unsaturated polyester resin component according to the invention is obtained or is obtainable from a monomer mixture comprising a polyfunctional alcohol component comprising at least one polyfunctional alcohol selected from the group consisting of aromatic polyfunctional alcohols, saturated aliphatic polyfunctional alcohols, and unsaturated aliphatic polyfunctional alcohols.

Preferably, the polyfunctional alcohol is a saturated aliphatic polyfunctional alcohol selected from the group consisting of saturated aliphatic diols, saturated aliphatic triols, saturated aliphatic tetraols.

Examples of saturated aliphatic polyfunctional alcohols include but are not limited to ethylene glycol, propylene glycol, 1,3-propanediol, 1,4-propanediol, 1,4-butanediol, 2,2-dimethyl-1,3-propanediol, 2-methyl-1,3-propanediol, glycerol, trimethylol propane and oxyalkylated adducts thereof such as glycol ethers, e.g. diethylene glycol, dipropylene glycol, and polyoxyalkylene glycol.

Preferably, the polyfunctional alcohol is an unsaturated aliphatic polyfunctional alcohol selected from the group consisting of unsaturated aliphatic diols, unsaturated aliphatic triols, unsaturated aliphatic tetraols.

Preferably, the polyfunctional alcohol is an aromatic polyfunctional alcohol selected from the group consisting of aromatic diols, aromatic triols and aromatic tetraols

Examples of aromatic polyfunctional alcohols include but are not limited to bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z.

In a preferred embodiment, the polyfunctional alcohol is selected from aliphatic and aromatic polyfunctional alcohols, wherein the term “aliphatic” covers acyclic and cyclic, saturated and unsaturated polyfunctional alcohols. Preferably, the polyfunctional alcohol is selected from aliphatic polyfunctional alcohols. More preferably, the polyfunctional alcohols are selected from aliphatic polyfunctional alcohols having from 2 to 12 carbon atoms. Still more preferably, the polyfunctional alcohols are selected from diols having from 2 to 10 carbon atoms, most preferably from diols having 3, 4, 6, 7, 8, 9 or 10 carbon atoms. It is particularly preferred that the polyfunctional alcohol is a diol having 3 carbon atoms.

Exemplary diols include alkanediols, butane-1,4-diol, 2-butyl-2-ethyl-1,3-propanediol (BEPD), 1,3-butylene glycol, butane-1,4-diol, cyclohexane-1,2-diol, cyclohexane dimethanol, diethyleneglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, ethylene-glycol, hexane-1,6-diol, 2-methyl-1,3-propanediol, neopentyl glycol, 5-norbornene-2,2-dimethylol, 2,3-norbornene diol, oxa-alkanediols, pentaerythritol, polyethylenepropane-3-diol, 1,2-propanediol, triethyleneglycol, trimethylolpropane, tripentaerythirol, 2,2,4-trimethyl-1,3-pentanediol, and 2,2-bis(p-hydroxycyclohexyl)-propane.

In a preferred embodiment, the polyfunctional alcohol is a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, hexane-1,6-diol, 2-methyl-1,3-propanediol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, tripentaerythritol, 2,2,4-trimethyl-1,3-pentanediol, and 2,2-bis(p-hydroxycyclohexyl)-propane. More preferably, the polyfunctional alcohol is selected from the group consisting of 1,2-propanediol (1,2-propylene glycol), dipropylene glycol, and cyclohexane-1,2-diol. Still more preferably, the polyfunctional alcohol is selected from 1,2-propanediol (1,2-propylene glycol) and dipropylene glycol. It is particularly preferred that the polyfunctional alcohol is 1,2-propanediol (1,2-propylene glycol), dipropylene glycol or a combination thereof. Most preferably, the polyfunctional alcohol is 1,2-propanediol (1,2-propylene glycol).

Preferably, the polyfunctional alcohol component comprises a mixture of at least two saturated aliphatic polyfunctional alcohols; preferably selected from the group consisting of propylene glycol, dipropylene glycol, ethylene glycol, and diethylene glycol.

Preferably, the weight content of the polyfunctional alcohol component is within the range of about 35±21 wt.-%, more preferably about 35±18 wt.-%, still more preferably about 35±15 wt.-%, yet more preferably about 35±12 wt.-%, even more preferably about 35±9 wt.-%, most preferably about 35±6 wt.-% and in particular about 35±3 wt.-%, in each case relative to the total weight of the polycarboxylic acid component, the polyfunctional alcohol component, the optionally present monocarboxylic acid component, and the optionally present monofunctional alcohol component.

The unsaturated polyester resin component according to the invention may be obtained or is obtainable from a monomer mixture optionally comprising a monocarboxylic acid component.

The monocarboxylic acid component preferably comprises a monocarboxylic acid selected from saturated aliphatic monocarboxylic acids, unsaturated aliphatic carboxylic acids, aromatic carboxylic acids, the salts, esters and anhydrides thereof.

Exemplary monocarboxylic acids include acrylic acid, benzoic acid, ethylhexanoic acid, and methacrylic acid. Preferred monofunctional carboxylic acids are acrylic acid and methacrylic acid.

The weight content of the monocarboxylic acid component may be within the range of from about 0.01 wt.-% to about 10 wt.-%, more preferably from about 0.01 wt.-% to about 2 wt.-%, relative to the unsaturated polyester resin system.

In a preferred embodiment, the unsaturated polyester resin component according to the invention is obtained or is obtainable from a monomer mixture comprising a monocarboxylic acid component, wherein the weight content of the monocarboxylic acid component, relative to the total weight of the unsaturated polyester resin component is not more than about 7.0 wt.-%, more preferably not more than about 6.0 wt.-%, still more preferably not more than about 5.0 wt.-%, yet more preferably not more than about 4.0 wt.-%, even more preferably not more than about 3.0 wt.-%, most preferably not more than about 2.0 wt.-% and in particular not more than about 1.0 wt.-%.

In another preferred embodiment, the unsaturated polyester resin component according to the invention is obtained or is obtainable from a monomer mixture not comprising any monocarboxylic acid component.

The unsaturated polyester resin component according to the invention may be obtained or is obtainable from a monomer mixture optionally comprising a monofunctional alcohol component. Preferably, the unsaturated polyester resin component according to the invention comprises at least one monofunctional alcohol selected from aromatic monofunctional alcohols, saturated aliphatic monofunctional alcohols, and unsaturated aliphatic monofunctional alcohols.

Exemplary monofunctional alcohols include benzyl alcohol, cyclohexanol, 2-ethyhexyl alcohol, 2-cyclohexyl ethanol, and lauryl alcohol.

Preferably, the unsaturated polyester resin component according to the invention comprises at least one aromatic monofunctional alcohols, preferably benzyl alcohol.

Preferably, the weight content of the monofunctional alcohol component is within the range of about 7.0±6.5 wt.-%, more preferably about 7.0±6.0 wt.-%, still more preferably about 7.0±5.0 wt.-%, yet more preferably about 7.0±4.0 wt.-%, even more preferably about 7.0±3.0 wt.-%, most preferably about 7.0±2.0 wt.-% and in particular about 7.0±1.0 wt.-%, in each case relative to the total weight of the polycarboxylic acid component, the polyfunctional alcohol component, the optionally present monocarboxylic acid component, and the optionally present monofunctional alcohol component.

Preferably, the unsaturated polyester resin component according to the invention comprises both, a polyfunctional alcohol component comprising at least two saturated aliphatic diols as well as a monofunctional alcohol component.

Preferably,
the molar content of the at least two saturated aliphatic diols is within the range of about 88±11 mole.-%, more preferably about 88±10 mole.-%, still more preferably about 88±9 mole.-%, yet more preferably about 88±8 mole.-%, even more preferably about 88±6 mole.-%, most preferably about 88±4 mole.-%, and in particular about 88±2 mole.-%, based on all saturated aliphatic diols; and/or
the molar content of the at least one monofunctional alcohol is within the range of about 12±11 mole.-%, more preferably about 12±10 mole.-%, still more preferably about 12±9 mole.-%, yet more preferably about 12±8 mole.-%, even more preferably about 12±6 mole.-%, most preferably about 12±4 mole.-%, and in particular about 12±2 mole.-%, based on all monofunctional alcohols; in each case relative to the total molar content of (ii) the polyfunctional alcohol component and (iv) the monofunctional alcohol component.

In a preferred embodiment, the unsaturated polyester resin component comprises
at least one aromatic dicarboxylic acid, anhydride or ester thereof selected from isophthalic acid, phthalic acid, and the anhydrides thereof; and/or
at least one saturated aliphatic dicarboxylic acid, anhydride or ester thereof which is adipic acid or adipic acid anhydride; and/or
at least one unsaturated aliphatic dicarboxylic acid, anhydride or ester thereof which is fumaric acid and the anhydrides thereof; and/or
at least two saturated aliphatic diols selected from the group consisting of propylene glycol, and diethylene glycol.

Without wishing to be bound to any scientific theory, a high content of fumaric double bonds in the polyester resin will give high crosslink density when the resin is cured and the adipic acid, due to its alkyl chain, will give flexibility to the cured polyester resin. A skilled person will recognize that another flexibilizing constituent is diethylene glycol.

Particularly preferred embodiments A¹ to A⁸, B¹ to B⁵, and C¹ to C⁷ of the unsaturated polyester resin component according to the invention are compiled in the tables here below. All values are provided in wt.-%, relative to the total weight of all monomers (polycarboxylic acid component, polyfunctional alcohol component, optionally present monocarboxylic acid component, and optionally present monofunctional alcohol component) from which the unsaturated polyester resin component is obtained (or obtainable):

| [wt.-%] | A¹ | A² | A³ | A⁴ | A⁵ | A⁶ | A⁷ | A⁸ |
|---|---|---|---|---|---|---|---|---|
| polyfunctional alcohol component | 36 ± 30 | 36 ± 26 | 36 ± 22 | 36 ± 18 | 36 ± 14 | 36 ± 10 | 36 ± 7 | 36 ± 3 |
| monofunctional alcohol component | 7 ± 6.5 | 7 ± 6 | 7 ± 5.5 | 7 ± 5 | 7 ± 4.5 | 7 ± 4 | 7 ± 3 | 7 ± 2 |
| polycarboxylic acid component | 57 ± 50 | 57 ± 45 | 57 ± 40 | 57 ± 35 | 57 ± 30 | 57 ± 25 | 57 ± 20 | 57 ± 15 |

| [wt.-%] | B¹ | B² | B³ | B⁴ | B⁵ |
|---|---|---|---|---|---|
| saturated aliphatic | 36 ± 30 | 36 ± 25 | 36 ± 20 | 36 ± 15 | 36 ± 10 |
| difunctional alcohol(s) | | | | | |
| aromatic | 7 ± 6.5 | 7 ± 6 | 7 ± 5 | 7 ± 4 | 7 ± 3 |
| monofunctional | | | | | |
| alcohol(s) | | | | | |
| saturated aliphatic | 8 ± 7 | 8 ± 6 | 8 ± 5 | 8 ± 4 | 8 ± 3 |
| dicarboxylic(s) acid or | | | | | |
| anhydride(s) thereof | | | | | |
| aromatic dicarboxylic | 17 ± 15 | 17 ± 13 | 17 ± 11 | 17 ± 9 | 17 ± 7 |
| acid(s) or anhydride(s) | | | | | |
| thereof | | | | | |
| unsaturated aliphatic | 32 ± 30 | 32 ± 25 | 32 ± 20 | 32 ± 15 | 32 ± 10 |
| dicarboxylic acid(s) or | | | | | |
| anhydride(s) thereof | | | | | |

| [wt.-%] | C¹ | C² | C³ | C⁴ | C⁵ | C⁶ | C⁷ | C⁷ |
|---|---|---|---|---|---|---|---|---|
| monopropylene glycol | 32 ± 30 | 32 ± 26 | 32 ± 22 | 32 ± 18 | 32 ± 14 | 32 ± 10 | 32 ± 7 | 32 ± 3 |
| diethylene glycol | 4 ± 3.6 | 4 ± 3.2 | 4 ± 2.8 | 4 ± 2.4 | 4 ± 2 | 4 ± 1.6 | 4 ± 1.2 | 4 ± 0.8 |
| benzyl alcohol | 7 ± 6.5 | 7 ± 6 | 7 ± 5.5 | 7 ± 5 | 7 ± 4.5 | 7 ± 4 | 7 ± 3.5 | 7 ± 3 |
| adipic acid or adipic acid anhydride | 8 ± 7.5 | 8 ± 7 | 8 ± 6 | 8 ± 5 | 8 ± 4 | 8 ± 3 | 8 ± 2 | 8 ± 1 |
| phthalic acid or phthalic acid anhydride | 17 ± 16 | 17 ± 14 | 17 ± 12 | 17 ± 10 | 17 ± 8 | 17 ± 6 | 17 ± 4 | 17 ± 2 |
| fumaric acid or fumaric acid anhydride | 32 ± 30 | 32 ± 26 | 32 ± 22 | 32 ± 18 | 32 ± 14 | 32 ± 10 | 32 ± 6 | 32 ± 2 |

In a preferred embodiment, the unsaturated polyester resin component according to the invention is obtained or is obtainable from a monomer mixture not comprising maleic acid, a salt, anhydride or ester thereof.

In another preferred embodiment, the unsaturated polyester resin component according to the invention is obtained or is obtainable from a monomer mixture comprising maleic acid, a salt, anhydride or ester thereof, wherein the weight content of maleic acid, a salt, anhydride or ester thereof, relative to the total weight of the unsaturated polyester resin component is not more than about 7.0 wt.-%, more preferably not more than about 6.0 wt.-%, still more preferably not more than about 5.0 wt.-%, yet more preferably not more than about 4.0 wt.-%, even more preferably not more than about 3.0 wt.-%, most preferably not more than about 2.0 wt.-% and in particular not more than about 1.0 wt.-%.

Another aspect of the invention relates to a prepromoted unsaturated polyester resin system for the preparation of engineered stone, which system comprises
(i) a unsaturated polyester resin component according to the invention as described above;
(ii) a metal catalyst capable of catalyzing curing of said unsaturated polyester resin component; preferably a zinc salt of a carboxylic acid, more preferably a zinc salt of a C₁₋₂₀ carboxylic acid, still more preferably a zinc salt of a C₆₋₁₂ carboxylic acid, most preferably zinc octanoate;
(iii) a quaternary ammonium salt; preferably a benzyl-N,N,N-trialkylammonium salt or a N,N,N,N-tetraalkylammonium salt; and
(iv) optionally, one or more additives selected from the group consisting of reactive diluents, accelerators, co-promoters, dispersing agents, UV absorbers, stabilizers, inhibitors and rheology modifiers.

All preferred embodiments of the unsaturated polyester component according to the invention that have been defined above analogously also apply to the prepromoted unsaturated polyester resin system according to the invention and thus, are not repeated hereinafter.

For the purpose of the invention, a “prepromoted” resin already contains the metal catalyst as promoter, but not yet the initiator (peroxide) for the radical reaction that causes curing. The prepromoted resin has long shelf-life and may be marketed as precursor. The initiator (peroxide) is then shortly added before the prepromoted resin is employed in the production of the final product, i.e. of the engineered stone.

Preferably, the prepromoted unsaturated polyester resin system according to the invention is cobalt free. For the purpose of the invention, “cobalt free” means that the system contains substantially no cobalt, preferably at most 10 ppm, more preferably at most 5 ppm, most preferably at most 1 ppm cobalt, and in particular no detectable cobalt at all. Suitable methods for determining the cobalt content of a system are known to the skilled person such as ESCA or high resolution inductively coupled plasma mass spectrometry.

In a preferred embodiment, not only the prepromoted unsaturated polyester resin system, but the entire formable composition according to the invention is cobalt free, i.e. the inorganic particulate material as well as the peroxide component are cobalt free as well, such that no cobalt is entrained.

It has been found that when employing zinc salts or copper salts instead of cobalt salts as metal catalysts (promoters), the cobalt free unsaturated polyester resin system has a long shelf life. Thus, the marketed cobalt free unsaturated polyester resin system may already initially contain the zinc salts or copper salts, thus rendering the unsaturated polyester resin system a “prepromoted” unsaturated polyester resin system. Thus, when preparing engineered stone from the prepromoted unsaturated polyester resin system according to the invention, only the initiator (peroxide) needs to be added, but not the metal catalyst (promoter), which is already contained. This makes the cobalt free unsaturated polyester resin system safer and easier to handle compared to conventional systems that require separate addition of initiator and cobalt promoter.

The prepromoted unsaturated polyester resin system according to the invention is preferably cobalt free. Thus, cobalt salts such as cobalt naphthenate or cobalt octoate, which are contained in conventional prepromoted unsaturated polyester resin systems for the preparation of engineered stone, are preferably not contained in the prepromoted unsaturated polyester resin system according to the invention.

The same applies to additives that are contained in conventional prepromoted unsaturated polyester resin system for the preparation of engineered stone in order to support the effect of the cobalt catalysts, such as dimethylaniline (DMA) or diethylaniline (DEA). Preferably, the prepromoted unsaturated polyester resin system according to the invention contains neither DMA nor DEA.

The prepromoted unsaturated polyester resin system according to the invention comprises a metal catalyst capable of catalyzing curing of said unsaturated polyester resin component.

Preferably, the metal catalyst that is contained in the prepromoted unsaturated polyester resin system according to the invention comprises zinc or copper, preferably in form of a zinc salt or a copper salt.

In a preferred embodiment, the metal catalyst is a zinc salt. The zinc salts of carboxylic acids are preferred. Non-limiting examples of typical zinc salts include the zinc salts of C₁₋₂₀ carboxylic acids and polycarboxylic acids, preferably zinc salts of C₆₋₁₂ carboxylic acid and polycarboxylic acids, including zinc acetate, zinc propionate, zinc butyrate, zinc pentanoate, zinc hexanoate, zinc heptanoate, zinc 2-ethyl hexanoate, zinc octanoate, zinc nonanoate, zinc decanoate, zinc neodecanoate, zinc undecanoate, zinc undecenylate, zinc dodecanoate, zinc palmitate, zinc stearate, zinc oxalate, and zinc naphthenate. Other zinc salts useful herein include the zinc salts of amino acids such as zinc alanine, zinc methionine, zinc glycine, zinc asparagine, zinc aspartine, zinc serine, and the like. Other zinc salts include zinc citrate, zinc maleate, zinc benzoate, zinc acetylacetonate, and the like. Other zinc salts include zinc chloride, zinc sulfate, zinc phosphate, and zinc bromide. The zinc chalcogens and zinc oxide can also be used. Zinc octoanate (zinc octoate) is particularly preferred.

In another preferred embodiment, the metal catalyst is a copper salt. Preferred copper salts are copper (I) salts or copper (II) salts. Preferred copper salts include but are not limited to copper acetate, copper octanoate, copper naphthenate, copper acetylacetonate, copper chloride or copper oxide.

The content of the metal catalyst, preferably zinc octanoate, relative to the total weight of the prepromoted unsaturated polyester resin system according to the invention, is preferably within the range of from about 0.001 wt.-% to about 1 wt.-%, more preferably about 0.001 wt.-% to about 0.02 wt.-%. Preferably, the content of the metal catalyst, preferably zinc octanoate, relative to the total weight of the prepromoted unsaturated polyester resin system according to the invention, is within the range of about 0.020±0.015 wt.-%, more preferably about 0.020±0.010 wt.-%, even more preferably about 0.020±0.004 wt.-%, still more preferably about 0.020±0.005 wt.-%, most preferably about 0.020±0.006 wt.-%.

The content of the metal catalyst, preferably zinc octanoate, relative to the total weight of the formable composition according to the invention, is preferably within the range of from about 0.0001 wt.-% to about 0.01 wt.-%, more preferably about 0.0001 wt.-% to about 0.002 wt.-%. Preferably, the content of the metal catalyst, preferably zinc octanoate, relative to the total weight of the formable composition according to the invention, is within the range of about 0.0020±0.0015 wt.-%, more preferably about 0.0020±0.0010 wt.-%, even more preferably about 0.0020±0.0005 wt.-%, still more preferably about 0.0020±0.0003 wt.-%, most preferably about 0.0020±0.0002 wt.-%.

The prepromoted unsaturated polyester resin system according to the invention comprises a quaternary ammonium salt, preferably a benzyl-N,N,N-trialkylammonium salt or a N,N,N,N-tetraalkylammonium salt.

Preferably, the quaternary ammonium salt that is contained in the prepromoted unsaturated polyester resin system according to the invention is a benzyl-N,N,N-trialkylammonium salt or a N,N,N,N-tetraalkylammonium salt. Preferred representatives include but are not limited to benzyl-N,N,N-trimethylammonium salts such as benzyl-N,N,N-trimethylammonium chloride; and benz-alkonium chlorides such as benzyl-N,N,N—C₂₋₂₀-alkyl-dimethyl-ammonium salts, e.g. benzyl-N,N,N—C₂20-alkyl-dimethyl-ammonium chloride, N,N—C₂₋₂₀-dialkyl-N,N-dimethyl ammonium salts, and the mixtures thereof.

The content of the quaternary ammonium salt, relative to the total weight of the prepromoted unsaturated polyester resin system according to the invention, is preferably within the range of from about 0.001 wt.-% to about 5 wt.-%, more preferably about 0.01 wt.-% to about 0.5 wt.-%. Preferably, the content of the quaternary ammonium salt, relative to the total weight of the prepromoted unsaturated polyester resin system according to the invention, is within the range of about 0.20±0.15 wt.-%, more preferably about 0.20±0.10 wt.-%, most preferably about 0.20±0.05 wt.-%.

The prepromoted unsaturated polyester resin system according to the invention may comprise one or more additives selected from the group consisting of reactive diluents, accelerators, co-promoters, dispersing agents, UV absorbers, stabilizers, inhibitors and rheology modifiers. Suitable additives are known to the skilled person. In this regard it can be referred to e.g. Ernest W. Flick, Plastics Additives, An Industrial Guide, 3rd ed. 2002, William Andrew Publishing.

The total content of optional additives, relative to the total weight of the prepromoted unsaturated polyester resin system according to the invention, is preferably within the range of from about 0.001 wt.-% to about 45 wt.-%, or about 1 wt.-% to about 45 wt.-%, more preferably about 10 wt.-% to about 45 wt.-%, even more preferably about 20 wt.-% to about 40 wt.-%, most preferably about 30 wt.-% to about 40 wt.-% or about 33 wt.-% to about 38 wt.-%.

Preferably, the prepromoted unsaturated polyester resin system comprises a reactive diluent selected from the group consisting of styrene, substituted styrene, mono-, di- and polyfunctional esters of monofunctional acids with alcohols or polyfunctional alcohols, mono-, di- and polyfunctional esters of unsaturated monofunctional alcohols with carboxylic acids or their derivatives.

Preferably, the reactive diluent comprises styrene and/or 1,4 butanediol methacrylate (BDDMA) and/or butyl methacrylate.

Preferably, the content of reactive diluent, preferably styrene, is within the range of about 30±8 wt.-%, more preferably about 30±7 wt.-%, still more preferably about 30±6 wt.-%, yet more preferably about 30±5 wt.-%, even more preferably about 30±4 wt.-%, most preferably about 30±3 wt.-% and in particular about 30±2 wt.-%, in each case relative to the total weight of the prepromoted unsaturated polyester resin system.

Inhibitors may be contained in the prepromoted unsaturated polyester resin system to lengthen the gel time (pot life). Inhibitors are useful when very long gel times are required or when resin is curing quickly due to high temperatures. Some common inhibitors include tertiary butyl catechol, hydroquinone, and toluhydroquinone.

Preferably, an inhibitor and a reactive diluent are mixed with the unsaturated polyester resin component simultaneously. Preferably, an inhibitor and a reactive diluent are mixed with the unsaturated polyester resin component before other additives are added.

Fillers may be contained in the prepromoted unsaturated polyester resin system. Alumina trihydrate may be contained e.g. to improve flame retardancy and reduce smoke emissions. Calcium carbonate, talc and kaolin clays may be contained e.g. to increase the stiffness. Silicon carbide and/or aluminum oxide may be contained in the prepromoted unsaturated polyester resin system e.g. to reduce liner deterioration caused by abrasion.

The prepromoted unsaturated polyester resin system may further comprise dispersing agents, which are chemicals that aid in the dispersion of solid components in the resin composition, i.e. enhance the dispersion of solid components in the unsaturated resin. Useful dispersing agents include but are not limited to copolymers comprising acidic functional groups like BYK®-W 996 available for Byk USA, Inc., Wallingford, Conn., U.S.A. (“Byk”), unsaturated polycarboxylic acid polymer comprising polysiloxane copolymer, like BYK®-W 995 available from Byk, copolymer comprising acidic functional groups, like BYK®-W 9011 available from Byk, copolymer comprising acidic functional groups, like BYK®-W 969 available from Byk and alkylol ammonium salt of an acidic polyester. Combinations of dispersing agents may be used.

The prepromoted unsaturated polyester resin system can comprise a co-promoter to enhance cure. Co-promoters useful in the invention include 2,4-petendione (“2,4-PD”), 2-acetylbutyrolactone, ethyl acetoacetonate, n,n-diethyl acetoacetamide and the like, and combinations thereof.

The prepromoted unsaturated polyester resin system may comprise a coupling agent. Coupling agents useful in the invention include but are not limited to silanes, e.g. 3-trimethoxy-silyl-propyl-methacrylate, and silane modified polyethylene glycol.

The prepromoted unsaturated polyester resin system may also comprise rheology modifiers. Typical rheology modifiers include fumed silica, organic clay and combinations thereof.

In addition, the prepromoted unsaturated polyester resin system may comprise other conventional additives such as synergist agents. These synergist agents include polysorbate 20 (Tween 20), polyhydroxycarboxylic acid esters, such as BYK®-R605 and R606 available from Byk and the like, and combinations thereof.

Another aspect of the invention relates to a formable composition for the preparation of engineered stone comprising

(A) a prepromoted unsaturated polyester resin system according to the invention as described above;
(B) an inorganic particulate material; and
(C) a peroxide component.

All preferred embodiments of the unsaturated polyester component according to the invention and of the prepromoted unsaturated polyester resin system according to the invention that have been defined above analogously also apply to the formable composition according to the invention and thus, are not repeated hereinafter.

The formable composition according to the invention has the advantage that it can be processed on conventional plants for the manufacture of engineered stone without any adaptations. Furthermore, as the unsaturated polyester resin system contained in the formable composition is prepromoted already, the final manufacturing process merely requires the mixing of (A), (B) and (C) with one another and thus, facilitates the process compared to conventional processes requiring separate addition of metal catalyst (promoter).

The formable composition according to the invention comprises an inorganic particulate material, preferably silicon dioxide, more preferably quartz and/or cristobalite. Typically, the inorganic particulate material is the main constituent of the formable composition and provides the engineered stone with the desired appearance.

Preferably, the inorganic particulate material is made from stone, e.g. crushed stone.

Preferably, the inorganic particulate material that is contained in the formable composition according to the invention comprises quartz and/or cristobalite.

In a preferred embodiment, the inorganic particulate material, preferably the silicon dioxide, more preferably fine quartz has an average particle size of not more than about 0.25 μm, more preferably not more than about 0.20 μm, still more preferably not more than about 0.18 μm, yet more preferably not more than about 0.16 μm, even more preferably not more than about 0.14 μm, most preferably not more than about 0.12 μm, and in particular not more than about 0.10 μm.

In another preferred embodiment, the inorganic particulate material, preferably the silicon dioxide, more preferably cristobalite has an average particle size within the range of about 45±35 μm, more preferably 45±30 μm, still more preferably 45±25 μm, yet more preferably 45±20 μm, even more preferably 45±15 μm, most preferably 45±10 μm and in particular 45±5 μm.

Suitable methods for determining the average particle size and particle size distribution of an inorganic particulate material are known to the skilled person such as laser light scattering according to ASTM C₁₀₇₀₋₀₁ (2014) or electric sensing zone technique according to ASTM C₆₉₀₋₀₉.

Preferably, the weight content of the inorganic particulate material is about 70 wt.-% to about 99.9 wt.-%, more preferably about 80 wt.-% to about 95 wt.-%, relative to the total weight of the formable composition. Preferably, the content of the inorganic particulate material is within the range of about 90±7 wt.-%, more preferably about 90±6 wt.-%, still more preferably about 90±5 wt.-%, yet more preferably about 90±4 wt.-%, even more preferably about 90±3 wt.-%, most preferably about 90±2 wt.-%, and in particular about 90±1 wt.-%, relative to the total weight of the formable composition.

In order to induce curing of the formable composition according to the invention, a radical initiator is needed. The initiator generates free radicals reacting with the ethylenic unsaturations of the unsaturated polyester resin component, thereby causing cross-linking of the polymer network. Preferred peroxides are organic peroxides that work together with the metal catalyst (promoters) to initiate the chemical reaction that causes a resin to gel and harden. The amount of time from which the peroxide is added until the resin begins to gel is referred to as the “gel time” or “pot life”. Peroxide and metal catalyst levels can be adjusted, to a certain extent, to shorten or lengthen the gel time and accommodate both high and low temperatures. If a longer gel time is required, inhibitors can be added.

Preferably, the peroxide component is a hydroperoxide and/or an organic peroxide, more preferably an organic hydroperoxide.

Preferably, the peroxide component is selected from the group consisting of methyl ethyl ketone peroxide (MEKP), methyl isobutyl ketone peroxide (MIKP), benzoyl peroxide (BPO), tert-butyl peroxibenzoate (TBPB), cumene hydroperoxide (CHP), and mixtures thereof.

Cumene hydroperoxide and/or methyl isobutyl ketone peroxide are particularly preferred. It has been surprisingly found that cumene hydroperoxide and/or methyl isobutyl ketone peroxide as peroxide component, preferably in combination with zinc salts or copper salts as metal catalysts (promoters), has particular advantages with respect to pot life, appearance and mechanical properties of the engineered stone, allowing for the complete omission of cobalt salts.

Preferably, the content of the peroxide component, preferably cumene hydroperoxide and/or methyl isobutyl ketone peroxide, is about 0.001 wt.-% to about 0.1 wt.-%, more preferably about 0.005 wt.-% to about 0.05 wt.-%, relative to the total weight of the formable composition. Preferably, the content of the peroxide component, preferably cumene hydroperoxide and/or methyl isobutyl ketone peroxide, relative to the total weight of the formable composition according to the invention, is within the range of about 0.20±0.15 wt.-%, more preferably about 0.20±0.10 wt.-%, most preferably about 0.20±0.05 wt.-%.

Preferably, the formable composition according to the invention is cobalt free.

Preferably, the content of the prepromoted unsaturated polyester resin system (total content of (i), (ii), (iii) and (iv)) is about 0.1 wt.-% to about 30 wt.-%, more preferably about 5 wt.-% to about 20 wt.-%, relative to the total weight of the formable composition. Preferably, the content of the prepromoted unsaturated polyester resin system (total content of (i), (ii), (iii) and (iv)) is within the range of about 10±7 wt.-%, more preferably about 10±6 wt.-%, still more preferably about 105 wt.-%, yet more preferably about 10±4 wt.-%, even more preferably about 10±3 wt.-%, most preferably about 10±2 wt.-%, and in particular about 10±1 wt.-%, relative to the total weight of the formable composition.

In preferred embodiments, the weight content of the prepromoted unsaturated polyester resin system is not more than about 15 wt.-%, more preferably not more than about 14 wt.-%, still more preferably not more than about 13 wt.-%, yet more preferably not more than about 12.5 wt.-%, even more preferably not more than about 12 wt.-%, most preferably not more than about 11.5 wt.-% and in particular not more than about 11 wt.-%, in each case relative to the total weight of the formable composition.

Preferably, the formable composition according to the invention has a pot life of at least about 30 minutes, more preferably at least about 1 hour, still more preferably at least about 1.5 hours and most preferably at least about 2 hours. Preferably, at 40° C. the pot life of the formable composition according to the invention, measured after mixing components (A) and (C) and optionally (B), is within the range of about 4.3±3.5 hours, more preferably about 4.3±3.0 hours, still more preferably about 4.3±2.5 hours, yet more preferably about 4.3±2.0 hours, even more preferably about 4.3±1.5 hours, most preferably about 4.3±1.0 hours, and in particular about 4.3±0.5 hours.

Preferably, the formable composition according to the invention has a polymerization time at 110° C. of at least about 30 minutes, more preferably at least about 1 hour. Preferably, at 110° C. the polymerization time of the formable composition according to the invention, is within the range of about 60±35 minutes, more preferably about 60±30 minutes, still more preferably about 60±25 minutes, yet more preferably about 60±20 minutes, even more preferably about 60±15 minutes, most preferably about 60±10 minutes, and in particular about 60±5 minutes.

Another aspect of the invention relates to a method for the preparation of a unsaturated polyester resin component according to the invention as described above comprising the step of reacting a mixture comprising
(i) a polycarboxylic acid component;
(ii) a polyfunctional alcohol component;
(iii) optionally, a monocarboxylic acid component; and
(iv) optionally, a monofunctional alcohol component;
   wherein the polycarboxylic acid component and/or the polyfunctional alcohol component and/or the monocarboxylic acid component and/or the monofunctional alcohol component comprises ethylenic unsaturation.

Preferably, the unsaturated polyester resin component is prepared in a process comprising the steps of
(a) mixing and heating the (i) polycarboxylic acid component, the (ii) polyfunctional alcohol component, and potassium acetate; and
(b) adding the optionally present (iv) monofunctional alcohol, a (i) polycarboxylic acid component differing from the (i) polycarboxylic acid component of step (a) and an inhibitor to the mixture obtained in step (a).

Still another aspect of the invention relates to an unsaturated polyester resin component that is obtainable by the above method.

Another aspect of the invention relates to a method for the preparation of a prepromoted unsaturated polyester resin system according to the invention as described above comprising the step of mixing
(i) a unsaturated polyester resin component according to the invention as described above;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

Preferably, in step (iv) of the method for the preparation of a prepromoted unsaturated polyester resin system an inhibitor and a reactive diluent are mixed with the unsaturated polyester resin component simultaneously. Preferably, in step (iv) of the method for the preparation of a prepromoted unsaturated polyester resin system an inhibitor and a reactive diluent are mixed with the unsaturated polyester resin component before other additives are added.

Still another aspect of the invention relates to an unsaturated polyester resin system that is obtainable by the above method.

Still another aspect of the invention relates to a method for the preparation of a formable composition according to the invention as described above comprising the step of mixing

(A) a prepromoted unsaturated polyester resin system according to the invention as described above;
(B) an inorganic particulate material; and
(C) a peroxide component.

Still another aspect of the invention relates to formable composition that is obtainable by the above method.

Another aspect of the invention relates to a method for the preparation of engineered stone comprising the steps of

(a) providing a formable composition according to the invention as described above;
(b) forming the composition prepared in step (a) into a desired shape; and
(c) allowing the composition formed in step (b) to cure.

Another aspect of the invention relates to engineered stone obtainable by the method according to the invention as described above.

All preferred embodiments of the unsaturated polyester component according to the invention, of the prepromoted unsaturated polyester resin system according to the invention, and of the formable composition according to the invention that have been defined above analogously also apply to the methods according to the invention as well as to the products obtainable by said methods and thus, are not repeated hereinafter.

Preferably, the engineered stone according to the invention has a flexural strength of at least about 70 MPa, more preferably at least about 80 MPa, still more preferably at least about 90 MPa, and most preferably at least about 100 MPa. Preferably, the flexural strength is within the range of about 105±35 MPa, more preferably about 105±30 MPa, still more preferably about 105±25 MPa, yet more preferably about 105±20 MPa, even more preferably about 105±15 MPa, most preferably about 105±10 MPa, and in particular about 105±5 MPa. Methods for determining the flexural strength of engineered stone are known to the skilled person, e.g. ASTM C₈₈₀.

Preferably, the engineered stone according to the invention has an impact resistance of at least about 4 J/m, more preferably at least about 6 J/m, still more preferably at least about 8 J/m, and most preferably at least about 10 J/m. Preferably, the impact resistance is within the range of about 11±7.0 J/m, more preferably about 11±6.0 J/m, still more preferably about 11±5.0 J/m, yet more preferably about 11±4.0 J/m, even more preferably about 11±3.0 J/m, most preferably about 11±2.0 J/m, and in particular about 11±1.0 J/m. Methods for determining the impact resistance of engineered stone are known to the skilled person, e.g. standard EN 41617-9.

Another aspect of the invention relates to the use of
a unsaturated polyester resin component according to the invention as described above;
a prepromoted unsaturated polyester resin system according to the invention as described above; or
a formable composition according to the invention as described above
   for the preparation of engineered stone.

All preferred embodiments of the unsaturated polyester component according to the invention, of the prepromoted unsaturated polyester resin system according to the invention, of the formable composition according to the invention, of the methods according to the invention as well as of the products obtainable by said methods that have been defined above analogously also apply to the uses according to the invention and thus, are not repeated hereinafter.

The following examples further illustrate the invention but are not to be construed as limiting its scope.

### EXAMPLE 1

An unsaturated polyester resin was prepared from the following monomers and subsequently mixed with styrene (reactive diluent):

| parts per weight | comparative | inventive |
|---|---|---|
| monopropylene glycol | 26 | 28 |
| diethylene glycol | 0 | 3 |
| benzyl alcohol | 0 | 6 |
| adipic acid | 0 | 6.7 |
| phthalic acid anhydride | 31 | 15 |
| maleic acid | 11 | 0 |
| fumaric acid | 0 | 28 |
| styrene | 37 | 22 |
| weight average M_{w} [g/mole] | | 2000 |

The preparation of the unsaturated polyester resin component comprised the steps of
(a) mixing and heating the monopropylene glycol (PG), diethylene glycol (DEG), adipic acid (AA), phthalic anhydride (PAN), and potassium acetate; and
(b) adding benzyl alcohol, fumaric acid and an inhibitor to the mixture obtained in step (a).

Stone slabs (thickness 2 cm) having the following composition were manufactured from the comparative and the inventive unsaturated polyester resin:

| | comparative | inventive |
|---|---|---|
| Resin % | 14 | 12 |
| Cristobalite filler 45 micron % | 28 | 30 |
| Cristobalite filler 45 micron % | 58 | 58 |

The mechanical properties of the obtained stone slabs were investigated and the results are summarized in the table here below:

| | comparative | inventive |
|---|---|---|
| Flexural strength [MPa] | 60 | 105 |
| Bending | yes | no |
| Impact resistance [J/m] | 6 | 11 |

It becomes clear from the above comparative data that the unsaturated polyester resin according to the invention provides engineered stone having superior properties compared to engineered stone manufactured from conventional unsaturated polyester resins.

### EXAMPLE 2 (COMPARATIVE) AND EXAMPLE 3 (COMPARATIVE)

Two unsaturated polyester resin were prepared from the following monomers:

| | example 2 | | example 3 | |
|---|---|---|---|---|
| | (comparative) | | (comparative) | |
| component | [g] | [mol] | [g] | [mol] |
| propylene glycol | 400.00 | 5.26 | 390.10 | 5.13 |
| diethylene glycol | 39.00 | 0.37 | 40.28 | 0.38 |
| inhibitor solution 25% HQ | 0.06 | | — | — |
| phosphoric acid | 0.05 | | — | — |
| phthalic anhydride | 474.00 | 3.20 | 229.64 | 1.55 |
| benzyl alcohol | — | — | 81.47 | 0.75 |
| maleic acid anhydride | 177.00 | 1.81 | 350.74 | 3.58 |
| inhibitor solution 25% HQ | 0.06 | | 0.132 | — |
| Total | 1090.17 | 10.64 | 1092.35 | 11.40 |
| Distillate | −90.17 | | −92.35 | |
| Plastic | 1000.00 | | 1092.35 | |

Synthesis of resin example 2 (comparative): propylene glycol, diethylene glycol, hydroquinone solution, phosphoric acid, phthalic anhydride and maleic anhydride were charged to a reactor equipped with a thermocouple, a mechanical stirrer, a fractionating column, a distillation head, a condenser and nitrogen sparge. Agitation was started as soon as a sufficient quantity of material was in the reactor. The reactor was sparged with nitrogen and heated to a temperature of 205±5° C., while maintaining the column top temperature at 100±2° C. Sampling for acid number and Brookfield CAP viscosity (first at 125° C. and later at 150° C., cone#3) was started as soon as a reactor temperature of greater than 200±5° C. was reached. When the acid number was 85-100 vacuum was applied and increased gradually. The reaction mixture was heated at 2055° ° C. under vacuum until Brookfield CAP viscosity (at 150° C., cone#3) of 2.2-2.6 P and an acid number of 30-40 mgKOH/g (100% solids) were reached. Then the vacuum was released and the reaction mixture was cooled to a temperature of 190-200° C. and the rest of hydroquinone solution added.

Synthesis of resin example 3 (comparative): propylene glycol, diethylene glycol, phthalic anhydride, benzyl alcohol, maleic anhydride and hydroquinone solution were charged to a reactor equipped with a thermocouple, a mechanical stirrer, a fractionating column, a distillation head, a condenser and nitrogen sparge. Agitation was started as soon as a sufficient quantity of material was in the reactor. The reactor was sparged with nitrogen and heated to a temperature of 205-210° C., while maintaining the column top temperature at 100±2° C. Sampling for acid number and Brookfield CAP viscosity (at 100° C., cone#3) was started as soon as reactor reached top temperature. When the acid number was 60-65 vacuum was applied and increased gradually. The reaction mixture was heated at 205-210° C. under vacuum until Brookfield CAP viscosity (at 100° C., cone#3) of 4.5-5.0 P and an acid number of 41-45 mgKOH/g (100% solids) were reached. Then the vacuum was released and the reaction mixture was cooled to a temperature of 1855° C.

The thus obtained comparative resins had the following properties:

| Molecular weight | example 2 | example 3 |
|---|---|---|
| and viscosity data: | (comparative) | (comparative) |
| Mn [g/mol] | 1563 | 1023 |
| Mw [g/mol] | 2726 | 1705 |
| Mp [g/mol] | 2306 | 1278 |
| Pdi | 1.74 | 1.67 |
| Viscosity (mPas) | 220-260 @ 150° C. | 450-500 @ 100° C. |
| AV | 30-40 | 41-45 |

After synthesis the comparative resins were mixed with styrene (reactive diluent) and other additives:

| | example 2 | | example 3 | |
|---|---|---|---|---|
| | (comparative) | | (comparative) | |
| component | [g] | wt.-% | [g] | wt.-% |
| styrene | 519.92 | 34 | 450.00 | 29 |
| copper naphthenate 8% | 0.05 | | — | |
| in styrene | | | | |
| hydroquinone 25% | 0.18 | | 0.30 | |
| in PGMME solution | | | | |
| further additives | 2.30 | | — | |
| sum additives | 522.45 | | 450.30 | |

Dilution of resin example 2 (comparative): resin was dropped slowly to a thin tank, which was charged beforehand with styrene (519.92 g), copper naphthenate 8% in styrene solution (0.05 g), and hydroquinone 25% in propylene glycol monomethyl ether (PGMME) solution (0.18 g). During drop, thin tank temperature was maintained at maximum 85±5° C. Mixing and cooling of the thin tank was continued until temperature was decreased below 40° C. The final resin was adjusted with additional additives.

Dilution of resin example 3 (comparative): resin was dropped slowly to a thin tank, which was charged beforehand with styrene (450 g), and hydroquinone 25% in propylene glycol monomethyl ether (PGMME) solution (0.3 g). During drop, thin tank temperature was maintained at maximum 805° C. Mixing and cooling of the thin tank was continued until temperature was decreased below 40° C. The final resin was adjusted with additional additives.

### EXAMPLE 4 (INVENTIVE)

An unsaturated polyester resin was prepared from the following monomers:

inventive example 4

| component | g | mol | wt.-% | mol.-% |
|---|---|---|---|---|
| propylene glycol | 384.59 | 5.06 | 33.10 | 44.75 |
| diethylene glycol | 38.24 | 0.36 | 3.29 | 3.19 |
| phthalic anhydride | 198.66 | 1.34 | 17.10 | 11.87 |
| adipic acid | 90.03 | 0.62 | 7.75 | 5.45 |
| potassium acetate | 0.05 | — | — | — |
| benzyl alcohol | 77.94 | 0.72 | 6.71 | 6.38 |
| maleic acid | — | — | — | — |
| anhydride | | | | |
| fumaric acid | 371.87 | 3.21 | 32.01 | 28.35 |
| inhibitor solution | 0.39 | | | |
| 25% HQ | | | | |
| Total | 1161.77 | 11.31 | | |
| Distillate | −161.77 | | | |
| Plastic | 1000.00 | | | |

The unsaturated polyester resin of example 4 was prepared in two steps. The first step comprised the reaction of the following monomers:

| component | [g] | [mol] |
|---|---|---|
| propylene glycol | 384.59 | 5.06 |
| diethylene glycol | 38.24 | 0.36 |
| phthalic anhydride | 198.66 | 1.34 |
| adipic acid | 90.03 | 0.62 |
| potassium acetate | 0.05 | — |

Propylene glycol, diethylene glycol, phthalic anhydride, adipic acid and potassium acetate were charged to a reactor equipped with a thermocouple, a mechanical stirrer, a fractionating column, a distillation head, a condenser and nitrogen sparge. Agitation was started as soon as a sufficient quantity of material was in the reactor. The reactor was sparged with nitrogen and slowly heated to a temperature of 205-210° C. First water distillate/exotherm was observed at a reaction temperature of 165-175° C. and the temperature of the water distillate at the column top was maintained at 100±2° C. As soon as exotherm was subsided the reaction temperature was further increased until the acid number of the product was about 75-85 (100% solids) and the reactor temperature was greater than 180° C. The reaction mixture was cooled to 150-170° C.

The second step comprised the reaction of the following components:

| component | [g] | [mol] |
|---|---|---|
| benzyl alcohol | 77.94 | 0.72 |
| fumaric acid | 371.87 | 3.21 |
| hydroquinone 25% in PGMME solution | 0.39 | |

Benzyl alcohol, fumaric acid and hydroquinone 25% in propylene glycol monomethyl ether (PGMME) solution were added to the reactor containing the reaction product of step 1. The reaction mixture was heated to a temperature of 205-210° C. as fast as possible, while maintaining the column top temperature at 100±2° C. Sampling for acid number and Brookfield CAP viscosity (at 100° C., cone#3 or #4) was started as soon as a reactor temperature of greater than 180° C. was reached. When the acid number was smaller 70 and/or the column top temperature dropped below 80° C., vacuum was applied and increased gradually. The reaction mixture was heated at 205-210° C. under vacuum until Brookfield CAP viscosity (at 100° C., cone#3 or #4) of 4,0-4,5 P and an acid number of 27-37 mgKOH/g (100% solids) were reached. Then the vacuum was released and the reaction mixture was cooled to a temperature of 1805° C.

The thus obtained inventive polyester resins had the following properties:

| Molecular weight and viscosity | inventive |
|---|---|
| data | example 4 |
| Mn [g/mol] | 1047 |
| Mw [g/mol] | 2000 |
| Mp [g/mol] | 1663 |
| Pdi | 1.91 |
| Viscosity (mPas) @ 100° C. | 400-450 |
| AV | 27-37 |

After synthesis the inventive polyester resins were mixed with styrene (reactive diluent) and other additives:

inventive
example 5

| component | [g] | wt.-% |
|---|---|---|
| styrene | 423.00 | 29 |
| hydroquinone 25% in PGMME solution | 0.10 | |
| further additives | 15.22 | |
| sum additives | 438.32 | |

The thus obtained resin was diluted in styrene. The resin was dropped slowly to a thin tank, which was charged beforehand with styrene (423 g, 10.46 mol) and hydroquinone 25% in propylene glycol monomethyl ether (PGMME) solution (0,098 g). During drop, thin tank temperature was maintained at maximum 805° C. Mixing and cooling of the thin tank was continued until temperature was decreased below 35° C. The final resin was adjusted with additional additives.

### EXAMPLES 5 TO 9 (COMPARATIVE), AND EXAMPLES 10 TO 13 (INVENTIVE)

Stone slabs were manufactured from the comparative polyester resins of examples 2 and 3 and the inventive unsaturated polyester resin of example 4. The mechanical properties of the obtained stone slabs were investigated. The compositions of the stone slabs and the mechanical properties of the stone slabs are summarized in the table here below:

| Example | comp. 5 | comp. 6 | comp. 7 | comp. 8 | comp. 9 | inv. 10 | inv. 11 | inv. 12 | inv. 13 |
|---|---|---|---|---|---|---|---|---|---|
| Resin | of example 2 (comp.) | | | of example 3 (comp.) | | of example 4 (inv.) | | | |
| Molecular weight | 2726 g/mol | | | 1705 g/mol | | 2000 g/mol | | | |
| Resin [wt.-%] | 10 | 12 | 14 | 10 | 12 | 10 | 12 | 14 | 12 |
| Cristobalite Filler | — | 30 | 30 | — | 30 | — | 30 | 30 | 30 |
| 45 microns [wt.-%] | | | | | | | | | |
| 0.1-0.4 Cristobalite | — | 58 | 56 | — | 58 | — | — | 56 | 58 |
| [wt.-%] | | | | | | | | | |
| Quartz Filler | 30 | — | — | 30 | — | 30 | — | — | — |
| 45 Microns [wt.-%] | | | | | | | | | |
| 0.1-0.3 Quartz [wt.-%] | 35 | — | — | 35 | — | 35 | 58 | — | — |
| 0.3-0.6 Quartz [wt.-%] | 25 | — | — | 25 | — | 25 | — | — | — |
| SUM | 100 | 100 | 100 | 100 | 100 | 100 | 100 | 100 | 100 |
| TiO₂ on resin [wt.-%] | 10 | 10 | 10 | 10 | 10 | 10 | 10 | 10 | 10 |
| Cobalt (6%) on resin | 0.20 | 0.20 | 0.20 | 0.20 | 0.20 | 0.20 | 0.20 | 0.20 | 0.20 |
| [wt.-%] | | | | | | | | | |
| TBPB on Resin [wt.-%] | 2 | 2 | 2 | 2 | 2 | 2 | 2 | 2 | 2 |
| Memo silane on resin | 2 | 2 | 2 | 2 | 2 | 2 | 2 | 2 | 2 |
| [wt.-%] | | | | | | | | | |

| Slab prepared from | comp. 5 | comp. 6 | comp. 7 | inv. 8 | inv. 9 | inv. 10 | inv. 11 | inv. 12 | inv. 13 |
|---|---|---|---|---|---|---|---|---|---|
| Slab thicknes [cm] | 2 | 2 | 2 | 2 | 2 | 2 | 2 | 2 | 2 |
| Flexural Strength [MPa] | 65 | 60 | 75 | 55 | 65 | 70 | 95 | 100 | 105 |
| Wetting | good | dry/mass | good | bad, | good | bad, | good | good | good |
| | | not uniform | | too wet | | too wet | | | |
| Bending | no | no | yes | yes | no | no | no | some | no |
| Cracks | no | no | no | yes | yes | yes | no | some | no |
| Impact Resistance [J/m] | 5 | 5 | 5 | 3 | 4 | 6 | 9.5 | 9 | 11 |
| UV after 1000 h QUV A | 7.9 | 8 | 8.2 | — | — | 7 | 6.8 | 7 | 6.8 |
| db | | | | | | | | | |

The following table shows the common industrial standard for mechanical properties of engineered stone slabs:

| | industrial |
|---|---|
| | standard |
| slab thickness [cm] | 2 |
| Flexural Strength [MPa] | >45 |
| wetting | good |
| Bending | no |
| cracks | no |
| Impact Resistance [J/m] | >4 |
| UV after 1000 h QUV A db | <10 |
| slab thickness [cm] | |

Accelerated weathering (QUV) simulates damaging effects of long term outdoor exposure of materials. The test was carried out according to ASTM method G 154 (QUV A). Stone slabs were exposed to varying conditions: ultraviolet radiation, moisture and heat. In the test, UV radiation (UV cycle: 8 h 60° C.) and water vapor (condensation cycle: 4 h 50° C.) conditions are alternated. Overall exposure time was 1000 h. The degree of color change due to weathering and UV-exposure is measured with the value “db”. The value “db” is related to yellowing of the stone slabs, wherein an increase of the db-value or a positive db-value indicates that the change is to a more (darker) yellow color of the artificial stone slabs and a decrease of the db-value or a negative db-value indicates a change to a more blue color of the artificial stone slabs.

The experimental data shows that the unsaturated polyester resin according to the invention provides engineered stone having superior properties compared to engineered stone manufactured from conventional unsaturated polyester resins with respect to changes in color. Whereas the stone slabs manufactured from conventional unsaturated polyester resins had db-values around 8 the slabs prepared from the inventive polyester resin had db-values around 7, i.e. showed less yellowing.

The above comparative data illustrates that the unsaturated polyester resin according to the invention provides engineered stone having superior properties compared to engineered stone manufactured from conventional unsaturated polyester resins. The engineered stone slabs prepared from the inventive unsaturated polyester resins showed improved mechanical properties compared to stone slabs prepared from unsaturated polyester resin having a molecular weight of more than about 2500 g/mol.

The experimental data illustrates that resins comprising fumaric acid and a saturated polycarboxylic acid such as adipic acid show improved mechanical properties. The resins employed in the manufacture of the stone slabs of comparative examples 5 to 9 did not comprise fumaric acid or a saturated polycarboxylic acid. The stone slabs prepared therefrom showed a flexural strength of up to 75 MPa and an impact resistance of up to 5 J/m. The resins employed in inventive examples 10 to 13 comprised fumaric acid and a saturated polycarboxylic acid. In contrast thereto, the stone slabs prepared from the inventive resins showed a flexural strength of up to 105 MPa and an impact resistance of up to 11 J/m.

Further, the stone slabs of comparative examples 8 and 9 had cracks. Said stone slabs were prepared from resins comprising a rather high content of maleic acid anhydride and a rather low content of diethylene glycol. Without wishing to be bound to any scientific theory, the cracks in the engineered stone slabs may be caused by the reactivity of the reactive double bonds of the maleic acid anhydride and also by the low content of diethylene glycol.

Further, the experimental data illustrates that the inventive unsaturated polyester resins show improved properties when employed with cristobalite fillers in the manufacture of engineered stone slabs compared to conventional resins which show poor properties when employed with cristobalite fillers.

The engineered stone slabs of comparative examples 6 and 9 and of inventive example 13 have the same content of resin and cristobalite fillers. Whereas the slabs of comparative examples 6 and 9 showed poor wetting properties or cracks in the stone slabs, the slabs prepared from the inventive resin in example 13 showed good wetting properties, did not bend and had no cracks.

Further, the stone slabs prepared from the inventive resin with cristobalite had considerably better mechanical properties. The flexural strength of the stone slab of example 13 was 105 MPa compared to only 60 MPa and 65 Mpa, respectively, of the stone slabs of comparative examples 6 and 9. Furthermore, the impact resistance was higher (inventive: 11 J/m vs. comparative: 5 J/m).

1. An unsaturated polyester resin component for the preparation of engineered stone, wherein the unsaturated polyester resin component has a weight average molecular weight of not more than about 2500 g/mol and is obtained by reacting a mixture comprising
(i) a polycarboxylic acid component comprising at least 2 polycarboxylic acids wherein a first carboxylic acid is selected from the group consisting of unsaturated aliphatic polycarboxylic acids, anhydrides or esters thereof and a second polycarboxylic acid is selected from the group consisting of saturated aliphatic polycarboxylic acids, anhydrides or esters thereof;
(ii) a polyfunctional alcohol component comprising at least one polyfunctional alcohol selected from the group consisting of saturated aliphatic polyfunctional alcohols and unsaturated aliphatic polyfunctional alcohols;
(iii) optionally, a monocarboxylic acid component comprising at least one monocarboxylic acid selected from aromatic monocarboxylic acids, anhydrides or esters thereof; saturated aliphatic monocarboxylic acids, anhydrides or esters thereof; and unsaturated aliphatic monocarboxylic acids, anhydrides or esters thereof; and
(iv) optionally, a monofunctional alcohol component comprising at least one monofunctional alcohol selected from aromatic monofunctional alcohols, saturated aliphatic monofunctional alcohols, and unsaturated aliphatic monofunctional alcohols;
wherein the polycarboxylic acid component and/or the polyfunctional alcohol component and/or the monocarboxylic acid component and/or the monofunctional alcohol component comprises ethylenic unsaturation.

2. The unsaturated polyester resin component according to claim 1, wherein
(i) the polycarboxylic acid component comprises fumaric acid and adipic acid; and
(ii) the polyfunctional alcohol component comprises propylene glycol and diethylene glycol.

3. The unsaturated polyester resin component according to claim 1 or 2, which has
a weight average molecular weight of not more than about 2000 g/mol; preferably not more than about 1500 g/mol; and/or
a viscosity in the range of about 150 to about 400 mPas.

4. The unsaturated polyester resin component according to any of the preceding claims, wherein the molar content of the second polycarboxylic acid which is selected from the group consisting of saturated aliphatic polycarboxylic acids, anhydrides is not more than 13.5 mole.-% relative to the molar content of the polycarboxylic acid component.

5. The unsaturated polyester resin component according to any of the preceding claims, wherein the molar ratio of (saturated aliphatic polycarboxylic acids, anhydrides or esters thereof) to (unsaturated aliphatic polycarboxylic acids, anhydrides or esters thereof) in the polyester resin component is in the range of (0.5 to 1.5):(6.5-8.5).

6. The unsaturated polyester resin component according to any of the preceding claims, which has a viscosity in the range of about 400 to about 500 mPas at 100° C., preferably in the range of about 400 to about 450 mPas at 100° C.

7. The unsaturated polyester resin component according to any of the preceding claims, wherein the polycarboxylic acid component, preferably the unsaturated polyester resin component, does not comprise maleic acid or maleic acid anhydride.

8. The unsaturated polyester resin component according to any of the preceding claims, wherein
(i) the polycarboxylic acid component comprises a mixture of an aromatic polycarboxylic acid, anhydride or ester thereof; with a saturated aliphatic polycarboxylic acid, anhydride or ester thereof; and with an unsaturated aliphatic polycarboxylic acid, anhydride or ester thereof; and/or
(ii) the polyfunctional alcohol component comprises a mixture of at least two saturated aliphatic polyfunctional alcohols.

9. The unsaturated polyester resin component according to any of the preceding claims, wherein
(i) the weight content of the polycarboxylic acid component is within the range of about 55±31 wt.-%; and/or
(ii) the weight content of the polyfunctional alcohol component is within the range of about 35±21 wt.-%;
in each case relative to the total weight of the polycarboxylic acid component, the polyfunctional alcohol component, the optionally present monocarboxylic acid component, and the optionally present monofunctional alcohol component.

10. The unsaturated polyester resin component according to any of the preceding claims, wherein
(i) the weight content of the polycarboxylic acid component is within the range of about 55±5 wt.-%; and/or
(ii) the weight content of the polyfunctional alcohol component is within the range of about 35±6 wt.-%;
in each case relative to the total weight of the polycarboxylic acid component, the polyfunctional alcohol component, the optionally present monocarboxylic acid component, and the optionally present monofunctional alcohol component.

11. The unsaturated polyester resin component according to any of the preceding claims, wherein
(i) the polycarboxylic acid component comprises a mixture of
at least one aromatic dicarboxylic acid, anhydride or ester thereof; with
at least one saturated aliphatic dicarboxylic acid, anhydride or ester thereof; and with
at least one unsaturated aliphatic dicarboxylic acid, anhydride or ester thereof; and/or
(ii) the polyfunctional alcohol component comprises a mixture of at least two saturated aliphatic diols.

12. The unsaturated polyester resin component according to claim 11, wherein
the molar content of the at least one aromatic dicarboxylic acid, anhydride or ester thereof is within the range of about 25±23 mole.-%, based on all aromatic dicarboxylic acids, anhydrides or esters thereof; and/or
the molar content of the at least one saturated aliphatic dicarboxylic acid, anhydride or ester thereof is within the range of; and about 12.5±10.5 mole.-%, based on all saturated aliphatic dicarboxylic acids, anhydrides or esters thereof; and/or
the molar content of the at least one unsaturated aliphatic dicarboxylic acid, anhydride or ester thereof is within the range of about 65±31 mole.-%, based on all saturated aliphatic dicarboxylic acids, anhydrides or esters thereof;
in each case relative to the total molar content of (i) the polycarboxylic acid component.

13. The unsaturated polyester resin component according to claim 11, wherein
the molar content of the at least one aromatic dicarboxylic acid, anhydride or ester thereof is within the range of about 25±3 mole.-%, based on all aromatic dicarboxylic acids, anhydrides or esters thereof; and/or
the molar content of the at least one saturated aliphatic dicarboxylic acid, anhydride or ester thereof is within the range of; and about 12.5±1.5 mole.-%, based on all saturated aliphatic dicarboxylic acids, anhydrides or esters thereof; and/or
the molar content of the at least one unsaturated aliphatic dicarboxylic acid, anhydride or ester thereof is within the range of about 65±5 mole.-%, based on all saturated aliphatic dicarboxylic acids, anhydrides or esters thereof;
in each case relative to the total molar content of (i) the polycarboxylic acid component.

14. The unsaturated polyester resin component according to any of claims 11 to 13, wherein
the at least one aromatic dicarboxylic acid, anhydride or ester thereof is selected from isophthalic acid, phthalic acid, and the anhydrides thereof; and/or
the at least one saturated aliphatic dicarboxylic acid, anhydride or ester thereof is adipic acid or adipic acid anhydride; and/or
the at least one unsaturated aliphatic dicarboxylic acid, anhydride or ester thereof is selected from maleic acid, fumaric acid and the anhydrides thereof; and/or
the at least two saturated aliphatic diols are selected from the group consisting of propylene glycol, dipropylene glycol, ethylene glycol, and diethylene glycol.

15. The unsaturated polyester resin component according to any of claims 11 to 13, wherein
the at least one aromatic dicarboxylic acid, anhydride or ester thereof is selected from isophthalic acid, phthalic acid, and the anhydrides thereof; and/or
the at least one saturated aliphatic dicarboxylic acid, anhydride or ester thereof is adipic acid or adipic acid anhydride; and/or
the at least one unsaturated aliphatic dicarboxylic acid, anhydride or ester thereof is fumaric acid and the anhydrides thereof; and/or
the at least two saturated aliphatic diols are propylene glycol and diethylene glycol.

16. The unsaturated polyester resin component according to claim 14 or 15, wherein the molar ratio of (adipic acid or adipic acid anhydride) to (phthalic acid or phthalic acid anhydride) in the polyester resin component is in the range of (0.5 to 3):(1.5 to 3).

17. The unsaturated polyester resin component according to any of the preceding claims, which comprises
(iv) a monofunctional alcohol component comprising at least one monofunctional alcohol selected from aromatic monofunctional alcohols, saturated aliphatic monofunctional alcohols, and unsaturated aliphatic monofunctional alcohols.

18. The unsaturated polyester resin component according claim 17, wherein the weight content of the monofunctional alcohol component is within the range of about 7.0±6.5 wt.-%, relative to the total weight of the polycarboxylic acid component, the polyfunctional alcohol component, the optionally present monocarboxylic acid component, and the optionally present monofunctional alcohol component.

19. The unsaturated polyester resin component according claim 17, wherein the weight content of the monofunctional alcohol component is within the range of about 7.0±2.0 wt.-%, relative to the total weight of the polycarboxylic acid component, the polyfunctional alcohol component, the optionally present monocarboxylic acid component, and the optionally present monofunctional alcohol component.

20. The unsaturated polyester resin component according to any of claims 17 to 19, wherein the monofunctional alcohol component comprises benzyl alcohol.

21. The unsaturated polyester resin component according to any of claims 17 to 20, wherein
the molar content of the at least two saturated aliphatic diols is within the range of about 88±11 mole.-%, based on all saturated aliphatic diols; and/or
the molar content of the at least one monofunctional alcohol is within the range of about 12±11 mole.-%, based on all monofunctional alcohols;
in each case relative to the total molar content of (ii) the polyfunctional alcohol component and (iv) the monofunctional alcohol component.

22. The unsaturated polyester resin component according to any of claims 17 to 20, wherein
the molar content of the at least two saturated aliphatic diols is within the range of about 88±2 mole.-%; based on all saturated aliphatic diols; and/or
the molar content of the at least one monofunctional alcohol is within the range of about 12±2 mole.-%; based on all monofunctional alcohols;
in each case relative to the total molar content of (ii) the polyfunctional alcohol component and (iv) the monofunctional alcohol component.

23. A prepromoted unsaturated polyester resin system for the preparation of engineered stone, which system comprises
(i) a unsaturated polyester resin component according to any of claims 1 to 22;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

24. The prepromoted unsaturated polyester resin system according to claim 23, wherein the metal catalyst comprises zinc or copper.

25. The prepromoted unsaturated polyester resin system according to claim 23 or 24, which is cobalt free.

26. The prepromoted unsaturated polyester resin system according to any of claims 23 to 25, wherein the quaternary ammonium salt is a benzyl-N,N,N-trialkylammonium salt or a N,N,N,N-tetraalkylammonium salt.

27. The prepromoted unsaturated polyester resin system according to any of claims 23 to 26, which comprises a reactive diluent selected from the group consisting of styrene, substituted styrene, mono-, di- and polyfunctional esters of monofunctional acids with alcohols or polyfunctional alcohols, mono-, di- and polyfunctional esters of unsaturated monofunctional alcohols with carboxylic acids or their derivatives.

28. The prepromoted unsaturated polyester resin system according to claim 27, wherein the reactive diluent comprises styrene.

29. The prepromoted unsaturated polyester resin system according to any of claims 23 to 28, wherein the content of reactive diluent is within the range of about 30±8 wt.-%, more preferably about 30±2 wt.-%, relative to the total weight of the prepromoted unsaturated polyester resin system.

30. A formable composition for the preparation of engineered stone comprising
(A) a prepromoted unsaturated polyester resin system according to any of claims 23 to 29;
(B) an inorganic particulate material; and
(C) a peroxide component.

31. The formable composition according to claim 30, wherein the inorganic particulate material comprises silicon dioxide.

32. The formable composition according to claim 31, wherein the silicon dioxide is present as quartz and/or cristobalite.

33. The formable composition according to any of claims 30 to 32, wherein the silicon dioxide has an average particle size of not more than about 0.25 μm.

34. The formable composition according to any of claims 30 to 33, wherein the peroxide component is selected from the group consisting of is cumene hydroperoxide, methyl isobutyl ketone and peroxide and tert-butyl peroxibenzoate.

35. The formable composition according to claim 34, wherein the peroxide component is tert-butyl peroxibenzoate.

36. The formable composition according to any of claims 30 to 35, which is cobalt free.

37. The formable composition according to any of claims 30 to 37, wherein the weight content of the prepromoted unsaturated polyester resin system is about 0.1 wt.-% to about 30 wt.-%, relative to the total weight of the formable composition; and/or wherein the weight content of the inorganic particulate material is about 70 wt.-% to about 99.9 wt.-%, relative to the total weight of the formable composition.

38. The formable composition according to any of claims 30 to 37, wherein the weight content of the inorganic particulate material is within the range of about 90±5 wt.-%, relative to the total weight of the formable composition.

39. The formable composition according to any of claims 30 to 38, wherein the weight content of the prepromoted unsaturated polyester resin system is not more than about 15 wt.-%, relative to the total weight of the formable composition.

40. The formable composition according to any of claims 30 to 38, wherein the weight content of the prepromoted unsaturated polyester resin system is not more than about 12.5 wt.-%, relative to the total weight of the formable composition.

41. A method for the preparation of a unsaturated polyester resin component according to any of claims 1 to 22 comprising the step of reacting a mixture comprising
(i) a polycarboxylic acid component;
(ii) a polyfunctional alcohol component;
(iii) optionally, a monocarboxylic acid component; and
(iv) optionally, a monofunctional alcohol component;
wherein the polycarboxylic acid component and/or the polyfunctional alcohol component and/or the monocarboxylic acid component and/or the monofunctional alcohol component comprises ethylenic unsaturation.

42. A method for the preparation of a prepromoted unsaturated polyester resin system according to any of claims 23 to 29 comprising the step of mixing
(i) a unsaturated polyester resin component according to any of claims 1 to 22;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

43. A method for the preparation of a formable composition for the preparation of engineered stone according to any of claims 30 to 40 comprising the step of mixing
(A) a prepromoted unsaturated polyester resin system according to any of claims 23 to 29;
(B) an inorganic particulate material; and
(C) a peroxide component.

44. A method for the preparation of engineered stone comprising the steps of
(a) providing a formable composition according to any of claims 30 to 40;
(b) forming the composition prepared in step (a) into a desired shape; and
(c) allowing the composition formed in step (b) to cure.

45. Engineered stone obtainable by the method according to claim 44.

46. The engineered stone according to claim 45, which has a flexural strength within the range of about 105±10 MPa.

47. The engineered stone according to claim 45 or 46, which has an impact resistance within the range of about 11±3.0 J/m.

48. Use of a unsaturated polyester resin component according to any of claims 1 to 22 for the preparation of engineered stone.

49. Use of a prepromoted unsaturated polyester resin system according to any of claims 23 to 29 for the preparation of engineered stone.

50. Use of a formable composition according to any of claims 30 to 40 for the preparation of engineered stone.
